(19) United States
(12) Patent Application Publication
(10) Pub. No.: US 2022/0147950 A1
(43) Pub. Date: May 12, 2022

(54) INTELLIGENT SCHEDULING VIA A SECONDARY CALENDAR

(71) Applicant: Kronologic, Inc., Austin, TX (US)

(72) Inventors: Christopher Sean Anthony Lee, Austin, TX (US); James Edward Allison, III, Austin, TX (US)

(21) Appl. No.: 17/525,015

(22) Filed: Nov. 12, 2021

Related U.S. Application Data
(60) Provisional application No. 63/112,773, filed on Nov. 12, 2020.

(51) Int. Cl. G06Q 10/10

(52) U.S. Cl. CPC G06Q 10/1097; G06Q 10/1095

(57) ABSTRACT

Techniques described herein are directed to a scheduling platform configured to schedule appointments for a representative utilizing a secondary calendar. The representative may include an employee of an organization or other entity configured to receive work assignments. The representative may have associated therewith a primary calendar accessible and modifiable by the representative. The scheduling platform may generate the secondary calendar associated with the primary calendar, such as a duplicate thereof. The scheduling platform may receive a request for a meeting with the representative from a contact. The scheduling platform may determine a time for the meeting and may tentatively schedule the meeting on the secondary calendar. The scheduling platform may send an invitation for the meeting to the contact. Responsive to receiving an indication of acceptance of the meeting, the scheduling platform may cause a scheduled appointment associated therewith to be presented via the primary calendar of the representative.

### RELATED APPLICATIONS

This application claims priority to U.S. Provisional Patent Application Number 63/112,773, filed Nov. 12, 2020, and entitled “Intelligent Scheduling Via a Secondary Calendar,” the entire contents of which are incorporated herein by reference.

### BACKGROUND

Many work assignments involve meetings between a representative of the organization and another person, such as a client. Traditionally, meeting times are coordinated by the assigned representative and the other person, such as via electronic mail. For example, a representative may tentatively reserve multiple potential meeting times and provide the times to the other person for selection of a particular time for the meeting. However, this traditional system requires that the representative maintain the reserved times until the other person selects the particular time, which may take hours, days, and in some cases, weeks. Because the times are reserved on a schedule associated with the representative until a particular time is selected, this traditional scheduling system results in inefficiencies in scheduling and representative workload, as the representative may not schedule other meetings during the reserved times.

To address the scheduling inefficiencies, some organizations may utilize a scheduling system configured to coordinate meeting times between the representative and another person. The scheduling system may tentatively reserve one or more times on a calendar of the representative and may send an invitation for meeting to the other person. In response to receiving an acceptance of the invitation for a particular time, the scheduling system may reserve the particular time on the calendar of the representative. While the scheduling system improves upon traditional manual scheduling techniques, the presentation of a plurality of tentative reservations on the calendar of the representative can overwhelm the user and render the calendar useless due to an excess of information provided therein.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to generate a secondary calendar for scheduling appointments for a representative, as described herein.

FIG. 2 illustrates an example process for generating a first calendar for scheduling an appointment for a representative and causing the appointment to be presented via a second calendar associated with the representative, utilizing the techniques described herein.

FIG. 3 illustrates an example process for scheduling an appointment for a representative and causing the appointment to be presented via a calendar of the representative.

FIG. 4 illustrates an example process for identifying a representative to conduct an appointment with a contact and causing the appointment to be presented via a calendar of the representative, utilizing the techniques described herein.

FIG. 5 illustrates an example process for updating an intelligent scheduling system calendar based on an input by a representative via a calendar of the representative, utilizing the techniques described herein.

FIG. 6 illustrates an example process for scheduling an appointment for a representative and causing the appointment to be presented via a second calendar of the representative, utilizing the techniques described herein.

FIG. 7 is a block diagram illustrating an example system including a service computing device and a representative computing device usable to implement example techniques described herein.

### DETAILED DESCRIPTION

Techniques described herein are directed to a scheduling platform configured to intelligently schedule meetings for one or more representatives of an organization. A representative may include an employee of the organization or other entity configured to receive work assignments from the organization, such as a contractor, or the like. The representative may have associated therewith a first calendar. The representative may access, view, and/or modify the first calendar. The scheduling platform may generate a second calendar and may associate the second calendar with the representative. The scheduling platform may utilize the second calendar to schedule a plurality of appointments between the representative and a plurality of other people. Responsive to receiving an acceptance of an invitation for an appointment, the scheduling platform may cause the appointment to be presented via the first calendar, thus improving an efficacy of the first calendar by limiting data presented thereon to appointments that are relevant to the representative.

The scheduling platform may identify the first calendar of a representative. In some examples, the scheduling platform may generate a second calendar and may associate the representative therewith. In some examples, the second calendar may include a duplicate calendar of the first calendar. In such examples, the second calendar may include schedule data (e.g., appointments, meetings, reservations, tasks, blocked times, vacation days, etc.) and/or scheduling preference data (e.g., days/times for scheduling appointments, start/end times for working, etc.). In some examples, the second calendar may include a master calendar including data associated with calendars of one or more representatives. In various examples, the master calendar may have associated therewith scheduling data and/or scheduling preference data corresponding to the one or more representatives.

The scheduling platform may identify a task to be assigned. The task may include a work assignment for a representative to complete. In some examples, the task may include conducting a meeting with a contact. The contact may include a person outside the organization (e.g., not an employee or contractor thereof) or inside the organization (e.g., an employee or contractor thereof) associated with the task. In various examples, the scheduling platform may identify the task based on receiving a communication from the contact, such as an email, a notification (e.g., expression) of interest, a telephone call, or the like. In such examples, the communication may comprise a request associated with one or more services provided by the organization. For example, a contact may submit a request for a demonstration of capabilities (e.g., demo) from an organization. The scheduling platform may receive the request and determine that the request includes the task of conducting a demo. The scheduling platform may identify a representative of the organization to conduct the task and may schedule an appointment for the demo between the representative and the contact.

In some examples, the scheduling platform may access the second calendar to determine a time that is available for the task. The scheduling platform may send an invitation for an appointment at the time and may reserve the time on the second calendar. Responsive to receiving an indication of acceptance of the invitation, the scheduling platform may cause the appointment to be presented to the representative via the first calendar. Continuing the example from above, the scheduling platform may identify the representative and may determine a time available for the representative to conduct the demo with the contact. The scheduling platform may send an invitation for the appointment to the contact and may reserve (e.g., block) the time on the second calendar. Responsive to receiving an indication of acceptance of the appointment from the contact, the scheduling platform may cause the appointment to be presented to the representative via the first calendar. As such, the first calendar associated with a representative computing device may include appointments that are relevant to the user, thereby decreasing clutter and increasing efficacy of the first calendar to the representative.

Techniques described herein improve current scheduling systems. Traditional scheduling systems require a representative assigned to conduct a meeting to schedule a time with another person (e.g., a contact) for the meeting. However, this traditional system requires that the representative maintain the reserved times on the representative's calendar until the other person selects the particular time, which may take hours, days, and in some cases, weeks. Because the times are reserved on a schedule associated with the representative until a particular time is selected, this traditional scheduling system results in inefficiencies in scheduling and representative workload, as the representative may not schedule other meetings during the reserved times. The techniques described herein provide an automated scheduling system that may determine an open time and coordinate the time with the other person, tentatively holding the meeting time on the calendar of the representative. The scheduling platform may confirm the time and may present an appointment therefor on the representative's calendar. Accordingly, the techniques described herein improve the efficiency in scheduling over traditional systems, by coordinating meeting times automatically and out of view of the employee until the meeting is confirmed. Moreover, routing logic, machine learning, and the like can be used to dynamically identify a representative of a group of representatives to which a task will be assigned such as to efficiently and effectively balance task assignments across an organization. Thus, techniques described herein improve an existing technological process of appointment scheduling.

Furthermore, techniques described herein improve a computing system of a representative. As discussed above, traditional scheduling systems require a representative assigned to conduct a meeting to schedule a time with another person for the meeting. Oftentimes, the representative may have to send multiple messages with the other person to determine a time for the meeting, wasting time and computing resources associated with a computing device of the representative. The scheduling platform described herein may automate the scheduling process remotely (e.g., on a service computing system remote from the computing system), thereby improving the computing system of the representative by reducing an amount of resources (e.g., processing power, memory, etc.) required thereof to schedule the appointment. Additionally, by causing appointments that are relevant to the representative (e.g., accepted invitations) to be presented thereto, the techniques described herein reduce a total amount of data stored on or in association with the computing device of the representative. Furthermore, the scheduling platform described herein may reduce a total amount of network traffic by reducing a number of messages transmitted between a representative and another person to determine a time for the meeting.

These and other aspects are described further below with reference to the accompanying drawings. The drawings are merely example implementations and should not be construed to limit the scope of the claims. For example, while examples are illustrated in the context of a scheduling appointments for a representative of an organization, the techniques described herein may also be applied to any other type of scheduling.

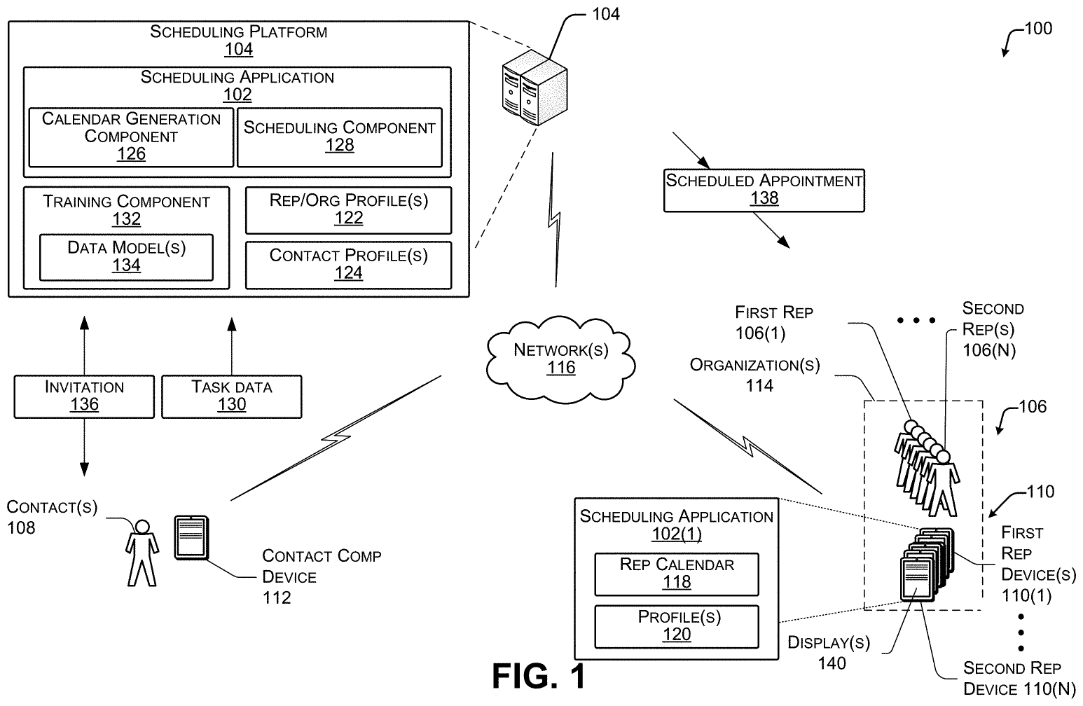

FIG. 1 is a schematic view of an example system 100 usable to implement the techniques described herein to provide automatic scheduling of appointments for tasks via a scheduling application 102. The system 100 may include a scheduling platform 104 configured to access and modify the scheduling application 102, such as to schedule appointments for tasks between one or more representatives 106(1) . . . 106(N) (collectively “representatives,” illustrated as reps for brevity) and one or more contacts 108(1) . . . 108(M) (collectively “contacts”). As illustrated, the representative(s) 106 may each have associated therewith a respective representative computing device 110(1) . . . 110(N) (“rep comp device 110”) and the contact(s) may each have associated therewith one or more contact computing devices 112. In various examples, the representative(s) 106 may include employees, contractors, or the like of an organization 114. In such examples, one or more of the representative computing device(s) 110 may include a computing device associated with an organization.

Each of the representative computing devices 110 and the contact computing device(s) 112 include one or more processors and memory storing computer executable instructions to implement the functionality discussed herein attributable to the various computing devices. In some examples, the representative computing devices 110 and the contact computing device(s) 112 may include desktop computers, laptop computers, tablet computers, mobile devices (e.g., smart phones or other cellular or mobile phones, mobile gaming devices, portable media devices, etc.), or other suitable computing devices. The representative computing devices 110 and the contact computing device(s) 112 may execute one or more client applications, such as a web browser (e.g., Microsoft Windows Internet Explorer, Mozilla Firefox, Apple Safari, Google Chrome, Opera, etc.) or a native or special-purpose client application (e.g., scheduling applications, email applications, etc.), to access and view content over the network 116.

The network 116 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the representative computing devices 110 and/or the contact computing device(s) 112 may access the scheduling platform 104 and/or communicate with one another.

The scheduling platform 104 may include one or more servers or other computing devices, any or all of which may include one or more processors and memory storing computer executable instructions to implement the functionality discussed herein attributable to a scheduling platform. The scheduling platform 104 may access a first instance of a scheduling application 102(1) on a first rep comp device 110(1), to facilitate scheduling an appointment for a task between the associated representative 106 and the contact 108. In some examples, the first instance of the scheduling application 102(1) may include a user interface via which the associated representative 106 may view appointments on the calendar associated therewith. The calendar may include appointments automatically scheduled by the scheduling platform 104 and/or appointments scheduled by the representative 106

In some examples, the scheduling platform 104 may manage the scheduling application 102. In such examples, the scheduling platform 104 may include the scheduling application 102. In some examples, the scheduling application 102 located on the scheduling platform 104 may include an application programming interface configured to communicate with the first instance of the scheduling application 102(1), such as to add create, modify and/or delete appointments on a calendar of a representative via the first instance of the scheduling application 102(1). Additionally, the application programming interface may be configured to receive data from a representative calendar 118 associated with the first instance of the scheduling application 102(1), such as to populate a secondary or master schedule comprising schedule and/or scheduling preference data associated with the representative 106(1).

In various examples, the rep comp device(s) 110 may store one or more profiles 120 associated with the representative and/or the organization. Similarly, the scheduling platform 104 may store one or more representative profiles and/or organization profiles 122. Representative profiles of the profile(s) 122 may include one or more characteristics associated with one or more representatives 106. The characteristics associated with a representative 106 may include a start time for a first task to be scheduled, an end time for a last task of the day to be started and/or finished (e.g., last task to start no later than 4 pm, last task to end no later than 4 pm, etc.), times for one or more breaks (e.g., lunch, coffee, smoke, etc.), maximum and/or minimum times to be scheduled for tasks (e.g., for each tasks based on task type, for all tasks, etc.), task scheduling preferences (e.g., maximum two tasks scheduled in a row for a representative, 15-minute break between scheduled tasks, maximum 5 tasks to be completed in a day, etc.), or the like. In some examples, the representative profiles of the profile(s) 122 may include historical performance data associated with a performance of the representative 106 at the organization and/or at other organizations. The historical performance data may include statistics associated with completing a task, converting a task to an opportunity (e.g., demonstration to a potential sale), converting an opportunity into a closed sale, average revenue per task performed, average profit per task performed, average cost per task performed, and the like.

The organization profiles of the profile(s) 122 may include one or more characteristics associated with one or more organizations 114. The characteristic(s) associated with the organization may include one or more task settings associated with requested tasks to be automatically scheduled (e.g., requested tasks, periodic tasks, etc.), one or more task scheduling preferences (e.g., maximum two tasks scheduled in a row for a representative, 15-minute break between scheduled tasks, maximum 5 tasks to be completed in a day, etc.), scheduling model preferences (e.g., overall model preferences, model preferences based on task type, etc.), performance characteristics (e.g., performance based on tasks completed per hour, tasks completed per day, revenue per task, etc.), and the like.

Additionally, in some examples, the scheduling platform 104 may include one or more contact profiles 124 associated with a contact. The contact may include a person outside the organization (e.g., not an employee or contractor thereof) associated with the task. In some examples, the contact may be a known entity (e.g., previous contact). In such examples, the scheduling platform may import contact data, such as from a contact profile 124 stored in a data store. The contact data may include one or more characteristics associated with the contact (e.g., name, position, address, electronic mail address, telephone number, social media handle, preferences, etc.), previous tasks associated with the contact, representatives assigned to the previous tasks, revenue collected from the contact 108 and/or an organization associated therewith, a position of the contact at the organization associated therewith (e.g., Chief Executive Officer (CEO), Chief Financial Officer (CFO), President, manager, etc.) and the like. In examples in which the contact is not a known entity (e.g., new contact), the scheduling platform may configure data collection fields to collect data from the contact. In such examples, responsive to receiving the data from the contact, the scheduling platform may generate a contact profile 124 associated with the (new) contact.

In various examples, the scheduling platform 104 may include a calendar generation component 126 that is configured to generate a secondary calendar associated with a rep calendar 118. The secondary calendar may include schedule data (e.g., appointments, meetings, reservations, tasks, blocked times, vacation days, etc.) and/or scheduling preference data (e.g., days/times for scheduling appointments, start/end times for working, etc.) associated with one or more representatives 106. In various examples, the secondary calendar may include a master calendar that is associated with one or more representatives 106. For example, the secondary calendar may include a master calendar that is associated with representatives 106 of an organization 114. For another example, the secondary calendar may include a master calendar that is associated with a particular group of representatives 106 of the organization 114.

In various examples, the secondary calendar may include a calendar that is associated with a particular representative, such as second representative 106(N). In various examples, the calendar generation component 126 may identify the particular representative 106 and a representative calendar 118 associated therewith, such as that stored in association with a second rep device 110(N). In various examples, the calendar generation component 126 generate the secondary calendar based at least in part on the particular representative 106(N) and/or the representative calendar 118 associated therewith.

In some examples, the secondary calendar may include a duplicate calendar of the representative calendar 118 associated with the second representative 106(N). In some examples, the calendar generation component 126 may receive calendar updates from an instance of the scheduling application associated with the second rep computing device 110(N), such as via an application programming interface. A calendar update may include data that the second representative 106(N) has added to, deleted from, or modified in the representative calendar 118 of the second representative 106(N). For example, a second representative 106(N) may add an appointment to a rep calendar 118 (e.g., a first calendar) at a particular time. The associated instance of the scheduling application 102 sends an update to the scheduling platform as a calendar update. The calendar generation component may update a secondary calendar (e.g., second calendar) associated with the second representative 106(N).

In various examples, the associated instance of the scheduling application 102(1) may be configured to send calendar updates for updating the secondary calendar responsive to receiving an update to the rep calendar 118. In such examples, the calendar generation component 126 may be configured to maintain a real-time and/or near real-time duplicate calendar of the rep calendar 118. In various examples, the associated instance of the scheduling application 102(1) may send the calendar updates periodically, such as every hour, daily, twice a day, or the like. The scheduling generation component may receive the calendar updates and may modify the secondary calendar to include the updated data. For example, a calendar update may include an indication that a representative scheduled an appointment during a period of time. The associated instance of the scheduling application 102(1) may send data associated with the appointment (e.g., date, time period, associated task, location, etc.) to the calendar generation component 126. Based on the data associated with the appointment, the calendar generation component 126 may update the secondary calendar to reflect a period of unavailability (e.g., render the period of time associated with the new appointment unavailable for scheduling a different appointment). For another example, a calendar update may include an indication that a representative canceled an appointment that was previously scheduled for a period of time. The associated instance of the scheduling application 102(1) may send an indication of the appointment cancellation to the calendar generation component 126. Based on the indication, the calendar generation component 126 may update the secondary calendar to render the period of time available for scheduling another (e.g., additional, alternate, etc.) appointment.

In various examples, a scheduling component 128 of the scheduling platform 104 may access one or more secondary calendars associated with the one or more representatives 106 to facilitate scheduling tasks (e.g., appointments, meetings, meeting types, etc.). In various examples, the scheduling component 128 may determine the task to be performed. In some examples, the scheduling component 128 may determine the task to be performed utilizing the techniques described in U.S. patent application Ser. No. 16/880,977, filed May 21, 2020 and entitled “Intelligent Scheduling,” the entire contents of which are incorporated herein by reference.

In various examples, the scheduling component 128 may determine the task to be performed based on input from a contact computing device 112 associated with a contact 108. In some examples, the input may include an indication of inefficient operation associated with an application (e.g., native application on the contact computing device 112, web application accessed via a web browser) and/or the operation of a unit of hardware provided by the organization. The indication of inefficient operation may include an indication to the scheduling component that the operator (e.g., contact) does not know how to properly operate the application and/or unit of hardware. For example, the indication of inefficient operation may include an indication that the operator “rage clicks” (e.g., a number of clicks per second exceeds a threshold number) on a selectable option on a page. Based on the indication of inefficient operation, the scheduling component 128 may determine that an enablement meeting task should be scheduled between the operator and a representative of the organization associated with the application, to assist the operator in determining an efficient operation of the application and/or to improve a user experience therewith.

In some examples, the scheduling component 128 may receive task data 130 from the contact computing device 112 associated with a contact 108. The task data 130 may include a request for a task to be performed by a representative 106 of the organization 114. For example, the task data 130 may include a request for a demonstration of capabilities of a product provided by the organization 114. The task data 130 may be transmitted via a communication from the contact 108 (e.g., via email, text message, etc.) and/or may be received via data collection fields associated with an application of the contact computing device (e.g., on a web application accessed via a web browser, native application, etc.). For example, the contact 108 may launch an application associated with the organization 114 on a contact computing device 112 and may submit a request for assistance with a software program provided by the organization 114. The request may include task data 130 describing the problem the contact 108 is experiencing. In some examples, the task data 130 may include an urgency associated with the request (e.g., level of importance, etc.). For example, the task data 130 may include a tier 1 level request for information technology (“IT”) support.

In various examples, the scheduling component 128 may determine one or more task characteristics associated with the task. The task characteristic(s) may include a task type (e.g., type of meeting requested, such as a demonstration, a check-in, enablement meeting, help desk ticket, etc.), a service associated with the task (e.g., update a product, fix a bug in software, stock shelves at a brick and mortar store, etc.), a time associated with the task (e.g., time created, time for completion, etc.), contact data associated therewith, level of importance, or the like. In various examples, scheduling component 128 may determine the task characteristic(s) based on the task data 130 and/or the task settings associated with an organization 114. In various examples, the scheduling component 128 may associate the task characteristic(s) with a contact 108. In at least one example, the scheduling platform may determine a task type (e.g., meeting type) based on the contact data and/or the source of the task (e.g., task settings) and may associate the meeting type with the contact 108, such as in the contact profile(s) 124.

In various examples, the scheduling component 128 may identify one or more representatives 106 (e.g., a group or team of representatives 106) that may perform the task. The scheduling component 128 may identify the representative(s) 106 that may perform the task utilizing one or more techniques described in U.S. patent application Ser. No. 16/880,977, incorporated herein by reference above. In various examples, the scheduling component 128 may identify the representative(s) 106 utilizing one or more rules. The rule(s) may be based on a type of task, a characteristic of the task, new contact, existing contact, contact preferences, representative characteristics (e.g., type of representative, area of expertise, etc.), pre-defined representative teams (e.g., predefined groups of representatives), or the like.

In some examples, the rule(s) may be determined utilizing machine learning techniques. In such examples, the scheduling platform may include a training component 132 configured to train one or more data models 134 to determine one or more rules, such as to maximize efficiencies associated with identifying the one or more representatives. In various examples, the training component 132 may utilize training data associated with tasks, task types, opportunities resulting from tasks, revenue resulting from opportunities, profit resulting from sales, times associated with the tasks, experience of the representative 106 performing the task, level of education and/or qualifications associated with the representative 106, and/or other information related to previously performed tasks, to train the data model to output one or more representatives 106 associated with an optimal efficiency.

In various examples, the scheduling component 128 may identify an available time on a secondary calendar associated with the one or more representatives 106 that may perform the task. In such examples, the secondary calendar may include a master calendar associated with the representative(s) 106. In various examples, the scheduling component 128 may identify a representative associated with the available time. In some examples, the representative may be assigned the task based on the time availability. For example, the scheduling component 128 may determine that a first representative 106(1) of a group of representatives 106 has a first available time period. Based on the first available time period, the scheduling component 128 may assign the task to the first representative 106(1).

In some examples, the scheduling component 128 may identify a particular representative for task assignment. In some examples, the particular representative 106(1) may be identified based on a performance score associated therewith, such as based on past performance (e.g., historical data, etc.). In various examples, the particular representative 106(1) may be identified based on an associated performance score being equal to or greater than a threshold performance score. In some examples, the particular representative 106(1) may be identified based on task data 130 associated with the task. In such examples, the representative may be selected based on difficulty of the task, urgency, visibility, or the like. For example, the scheduling component 128 may determine that a task indicates that the task is of high urgency and includes a high-profile contact 108 (e.g., CEO of another organization, high revenue client, etc.). Based on a determination that the task is high urgency and high-profile contact 108, the scheduling platform may identify the particular representative 106(1) for task assignment based on a determination that an associated performance score is above a threshold performance score. In various examples, responsive to identifying the particular representative 106(1), the scheduling component 128 may determine an available time for the particular representative 106(1) to perform the task.

In various examples, responsive to determining the time and/or the representative 106(1) associated with the task assignment, the scheduling component 128 may reserve the time on the secondary calendar of the representative 106(1), such as by generating a tentative appointment. The scheduling component may additionally generate an invitation 136 associated with the tentative appointment between the associated contact (e.g., requestor) and the representative 106(1). The invitation may include information regarding the tentative appointment, such as the time and/or the representative 106(1), information to be discussed (e.g., IT service call, demonstration, etc.), and the like. In various examples, the scheduling component 128 may send the invitation to the contact computing device 112.

Responsive to receiving an indication of acceptance of the invitation 136, the scheduling component 128 may, in some examples, confirm the time on the secondary calendar of the representative 106(1). In some examples, responsive to receiving the indication of acceptance of the invitation 136, the scheduling component 128 may send the scheduled appointment 138 to the representative computing device 110(1). In various examples, the scheduling component may cause the scheduled appointment 138 to be presented on a display 140 of the representative computing device 110(1), such as via the representative calendar 118.

In some examples, the scheduling component 128 may receive a response to the invitation 136 that includes an indication of unavailability at the proposed time (e.g., contact 108 declines invitation 136). In some examples, the response may include an alternative time for the appointment. In such examples, the scheduling platform may determine whether the representative 106(1) is available at the alternative time. Based on a determination that the representative 106(1) is available at the alternative time, the scheduling component 128 may send a scheduled appointment 138 for the alternative time to the representative computing device 110(1), for display via the representative calendar 118. Based on a determination that the representative 106(1) is not available at the alternative time, the scheduling component 128 may coordinate another time for the appointment between the contact 108 and the representative 106(1). For example, the scheduling component 128 may send one or more updated invitations 136 with different times for the appointment until receiving an indication of acceptance of the invitation 136. Responsive to receiving the indication of acceptance from the contact computing device 112, the scheduling component 128 may send the scheduled appointment 138 to the representative computing device 110(1) for display via the representative calendar 118.

Alternatively, based on a determination that the representative 106(1) is not available at the alternative time, the scheduling component 128 may identify another representative, such as representative 106(N), to perform the task. In such examples, the scheduling component 128 may send a scheduled appointment 138 to another representative computing device 110(N) associated with the other representative 106(N), for display via an associated representative calendar 118.

In various examples, the response to the invitation 136 that includes the indication of unavailability at the proposed time may include additional information. In some examples, the scheduling component 128 may determine that user intervention is required to understand the additional information. For example, the response may include an indication of unavailability with a note that the contact has a meeting from noon-2pm and another meeting from 2:30-3:30. The scheduling component 128 may determine that the additional information requires user intervention to identify an alternative time for the appointment.

Responsive to determining that user intervention is required, the scheduling platform may cause a notification to be presented on the representative computing device 110(1) associated with the representative 106(1). In some examples, the notification may be sent as a pop-up notification, such as in the first instance of the scheduling application 102(1), via an email, a text message, or any other means in which the notification may be presented to the representative 106(1). In various examples, the representative 106(1) may respond to the notification and may assist the scheduling component 128 in scheduling the appointment. Responsive to determining that the appointment is scheduled, the scheduling component 128 may cause the appointment to be presented on the rep computing device 110(1) via the rep calendar 118.

In various examples, the scheduling component 128 may send an invitation to a contact 108 for an appointment and may not receive a response (e.g., indication of acceptance, alternative time, additional data, etc.). In some examples, the scheduling component 128 may determine that a threshold period of time (e.g., three business days, five days, one week, one month, etc.) has elapsed since the invitation 136 was sent and may unblock the time associated with the appointment on the secondary calendar associated with the representative 106(1). In some examples, the scheduling component 128 may delete the tentative appointment from the secondary calendar based on a determination that the threshold period of time has elapsed. In some examples, the scheduling platform may delete the tentative appointment from the secondary calendar based on a determination that a time associated with the tentative appointment has passed.

In various examples, the scheduling component 128 may send an updated invitation to the contact 108 based on a determination that the threshold period of time has elapsed with no response. The updated invitation 136 may include a same or a different date, time, representative 106 as the originally provided invitation 136. For example, the scheduling component 128 may send a contact 108, at a first time, a first invitation 136 for a first meeting with a representative 106(1). Responsive to a determination that a threshold period of time has elapsed since the first time, the scheduling component 128 may send, at a second time, a second invitation 136 for the meeting with the representative. For another example, responsive to a determination that a threshold period of time has elapsed since the first time, the scheduling component 128 may send, at a second time, a second invitation 136 for a second meeting with the representative, the second meeting being associated with a different time from the time associated with the first meeting.

In various examples, the scheduling component 128 may withhold data associated with the invitations 136 from being presented via the rep calendar 118 of a rep computing device 110 until the invitation 136 is accepted by a contact 108. In such examples, the scheduling component 128 may improve the performance of the rep computing device 110 by limiting the scheduling data to be processed by the rep computing device 110 to data that is relevant to the representative 106. Additionally, by limiting the scheduling data sent to the representative computing device to relevant data, the scheduling component 128 may reduce a total amount of data transmitted via the network(s) 116 between the scheduling platform 104 and the rep computing device 110.

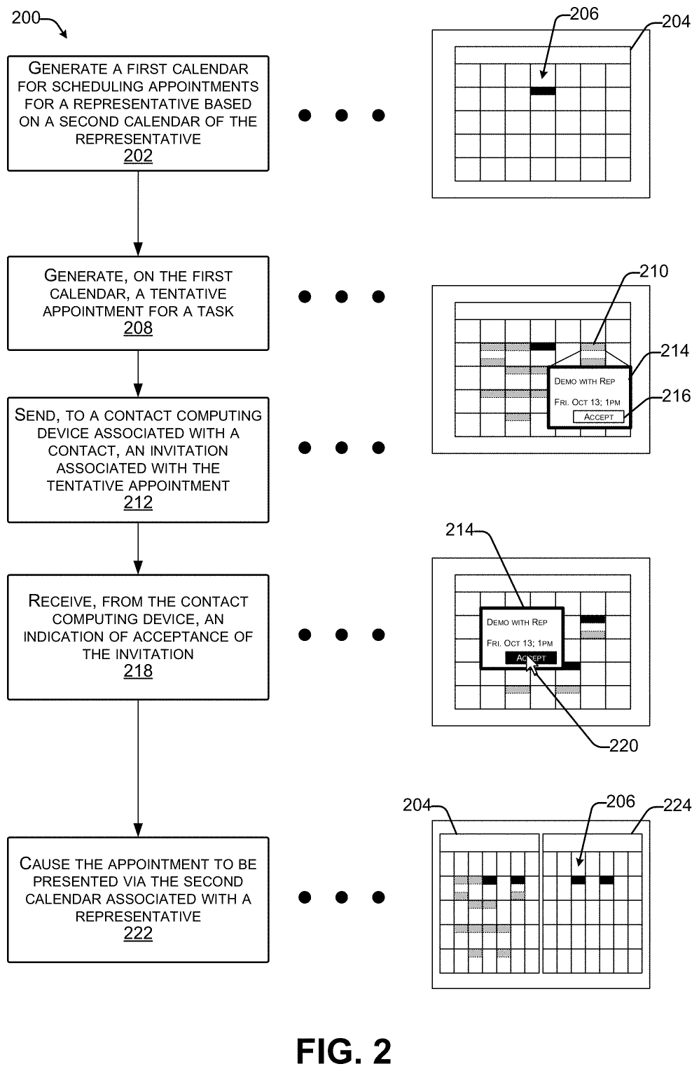

FIGS. 2-6 illustrate example processes (e.g., methods) in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

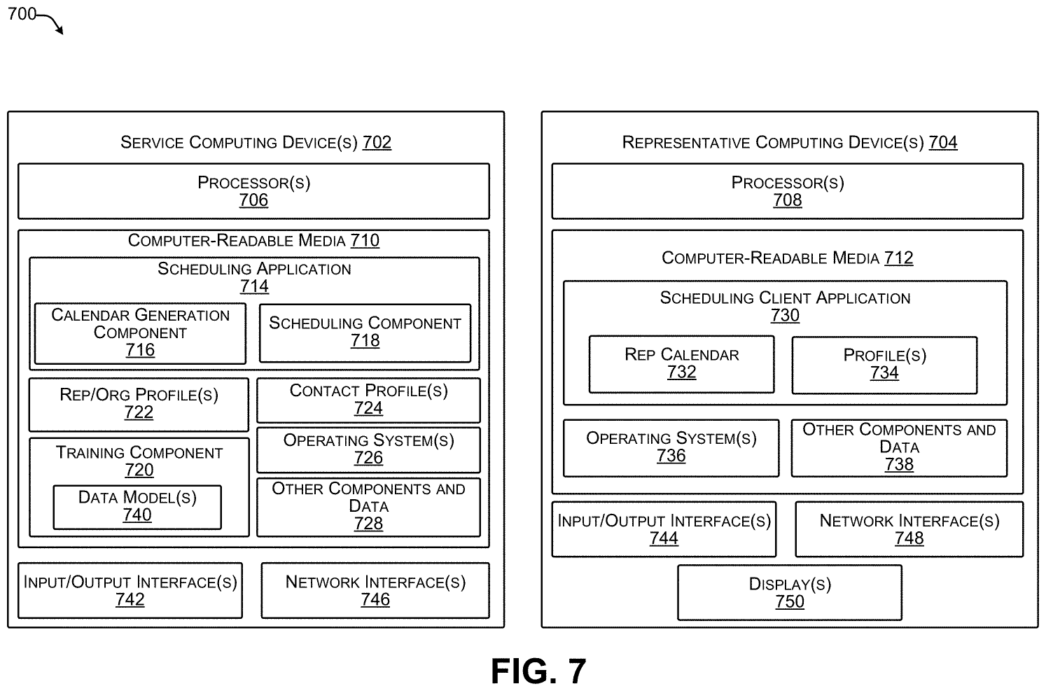

FIG. 2 illustrates an example process 200 for generating a first calendar for scheduling an appointment for a representative and causing the appointment to be presented via a second calendar of the representative. As discussed herein, a scheduling platform may be configured to automatically schedule a meeting (e.g., assign the task at a particular time, during a particular time slot, etc.) between a representative and a contact. In some instances, some or all of process 200 may be performed by one or more components in the system 100 (e.g., scheduling platform 104, representative computing device 110, and/or contact computing device 112) and/or by one or more components of the system 700 of FIG. 7 (e.g., service computing device 702 and/or representative computing device 704).

At operation 202, the scheduling platform may generate a first calendar 204 for scheduling appointments for a representative based on a second calendar of the representative. In some examples, the first calendar 204 may include a duplicate calendar of a representative calendar associated with the representative, such as representative calendar 118). In such examples, the first calendar 204 may include a secondary calendar associated with the representative calendar. In some examples, the first calendar 204 may be accessible to and maintained by the scheduling platform, while the second calendar may be accessible to and modifiable by the representative and/or the scheduling platform. For example, the representative may access the second calendar via a scheduling application on a representative computing device, such as rep computing device 110. Though discussed herein as being associated with a representative, it is understood that the first calendar 204 may include a master calendar associated with one or more representatives. In some examples, the one or more representatives may include representatives associated with an organization and/or a group of representatives of an organization (e.g., a team, etc.).

In some examples, the first calendar may include schedule data (e.g., appointments, meetings, reservations, tasks, blocked times, vacation days, etc.) and/or scheduling preference data (e.g., days/times for scheduling appointments, start/end times for working, etc.) associated with the second calendar of the representative. In some examples, the schedule data may include one or more one or more scheduled appointments 206 that are currently associated with the representative. In such examples, the scheduled appointment(s) 206 may include periods of time in which the representative is currently scheduled for a meeting, a task, an appointment, or is otherwise unavailable for scheduling. The scheduled appointment(s) 206 may include periods of time that are scheduled by the scheduling platform and/or by the representative via the second calendar.

In various examples, the scheduling platform may continuously and/or periodically update the first calendar 204 to include updated schedule data and/or scheduling preference data. In some examples, the scheduling platform may update the first calendar 204 based on receiving an indication that the representative added a scheduled appointment 206 to the second calendar. In some examples, the representative computing device associated with the representative may send updated schedule data to the scheduling platform based on the recently added scheduled appointment 206. In various examples, the scheduling platform may periodically (e.g., once per hour, twice per day, daily, weekly, etc.) request and/or receive updated schedule data from the representative computing device and/or the second calendar (e.g. an application associated therewith). Responsive to receiving updated schedule data, the scheduling platform may modify the first calendar 204 to include one or more appointment(s) 206 associated with the updated schedule data.

As discussed above, the scheduling platform may determine one or more tasks (e.g., meetings, appointments, etc.) for the representative to perform. In some examples, the scheduling platform may determine the task(s) based in part on a request for a representative to perform a task (e.g., a new task), such as that received from a contact. The task(s) may include one or more work assignments for a representative to complete. In some examples, the task(s) may include conducting one or more meetings with one or more contacts. For example, a plurality of contacts may submit a plurality of requests for demonstrations of capabilities (e.g., demos) from an organization. The scheduling platform may receive the plurality of requests and determine that each of the plurality of requests includes the task of conducting a demo. The scheduling platform may identify a representative of the organization to conduct the plurality of tasks and may identify a time on the first calendar associated with the representative for an appointment for each of the demos.

At operation 208, the scheduling platform may generate, on the first calendar, a tentative appointment 210 for a task. In some examples, the scheduling platform may generate a tentative appointment 210 for each task of the one or more received tasks. For example, as illustrated, the scheduling platform generates a tentative appointment 210 on Friday, Oct. 13, at 1 pm, for a task including a demo with a representative.

In some examples, the scheduling platform may generate two or more tentative appointments 210 for each task of the one or more tasks. In such examples, the scheduling platform may reserve two or more times for each task. In some examples, the scheduling platform may determine a number of tentative appointments 210 to schedule based on an urgency of a task, a task type, and/or a contact associated with a particular type. For example, a CEO of an organization may submit a request for a demonstration of capabilities. Based on a determination that the contact is the CEO of an organization, the scheduling platform may determine that the task is a high priority and may schedule three tentative appointments 210 associated with the task, to expedite appointment scheduling and/or to provide options for the CEO to select an appointment time.

At operation 212, the scheduling platform may send, to a contact computing device associated with a contact (e.g., corresponding to the task), an invitation 214 associated with the tentative appointment 210. In some examples, the scheduling platform may send an invitation 214 for each tentative appointment 210. As illustrated, the invitation 214 may include a description of the meeting, a date and/or time associated with the tentative appointment 210. In some examples, the invitation 214 may include representative data associated with the representative corresponding to the appointment (e.g., the representative associated with and/or assigned the task). In various examples, the invitation 214 may include an accept selectable option 216. In such examples, accept selectable option may enable the contact to quickly and easily accept the invitation. In some examples, responsive to receiving an indication of selection of the accept selectable option 216, the scheduling platform and/or the contact computing device (e.g., an application associated therewith) may add the appointment to a calendar associated with the contact.

In some examples, the invitation 214 may include data associated with one or more tentative appointments 210. In such examples, the invitation 214 may include one or more dates and/or times available for a task (e.g., a meeting with a representative). In some examples, the date(s) and/or time(s) may be selectable by the contact. Continuing the example of the CEO requesting a demonstration of capabilities from above, the scheduling platform may generate three tentative appointments 210 for times available for a demonstration. The scheduling platform may send, to a computing device associated with the CEO, an invitation 214 including three dates and/or times associated with the three tentative appointments 210. The three dates and/or times included in the invitation 214 may be selectable, such that the CEO may select a desired date and/or time for the appointment.

At operation 218, the scheduling platform may receive, from the contact computing device, an indication of acceptance of the invitation 214. In various examples, the indication of acceptance of the invitation 214 may include an indication that the contact 220 (illustrated as a cursor) selects the accept selectable option 216 included in the invitation 214. In some examples, the indication of acceptance may include an indication that the contact 220 adds the appointment to a calendar associated with the contact. In various examples, the indication of acceptance of the invitation 214 may be received via an email confirming acceptance, text message confirming acceptance, social messaging application message confirming acceptance, or the like. In various examples, the scheduling platform may modify the tentative appointment 210 into a scheduled appointment 206 on the first calendar 204.

In some examples, the indication of acceptance of the invitation 214 may include a selected date and/or time for the scheduled appointment 206. Continuing the example from above, the CEO may select, via the invitation 214, a desired date and/or time for the appointment. The date and/or time may be included in the indication of acceptance of the invitation 214. The scheduling platform may modify the selected tentative appointment 210 into the scheduled appointment 206 on the first calendar 204. In some examples, the scheduling platform may delete the other (unselected) tentative appointments 210 associated with the task.

At operation 222, the scheduling platform may cause the scheduled appointment 206 to be presented via the second calendar 224 associated with the representative. The second calendar 224 may be presented on a display of the representative computing device associated with the representative, such as via a scheduling application. In some examples, the scheduling platform may cause the scheduling application to present the scheduled appointment 206 on the display of the representative computing device. As illustrated, the second calendar 224 of the representative may include scheduled appointments 206. As such, the scheduling platform may withhold data associated with the tentative appointments 210 from view by the representative (e.g., not send to a representative computing device for presentation via the second calendar 224). In some examples, the scheduling platform may withhold data associated with a tentative appointment 210 from view until the tentative appointment 210 is accepted by a contact and becomes a scheduled appointment 206 (e.g., scheduling platform modifies the tentative appointment 210 into the scheduled appointment 206).

In some examples, the scheduling platform may withhold data associated with a tentative appointment 210 from view of a representative until the scheduling platform determines that representative input from the representative is needed to modify the tentative appointment into the scheduled appointment 206. In some examples, the scheduling platform may receive a response to the invitation and may determine that user intervention is needed. In such examples, the scheduling platform may cause a notification associated with the tentative appointment to be presented via the representative computing device. The notification may request the representative input from the representative. In various examples, the scheduling platform may receive a response to the request for representative input and based on the representative input, may send an updated invitation to the contact. Responsive to receiving an indication of acceptance of the updated invitation, the scheduling platform may modify the tentative appointment 210 into the scheduled appointment 206 and may cause it to be presented via the second calendar 224. In various examples, the scheduling platform may cause an indicator associated with the scheduled appointment to be presented via the second calendar 224, such as an indicator including data associated with the appointment the task, the contact, and/or the like.

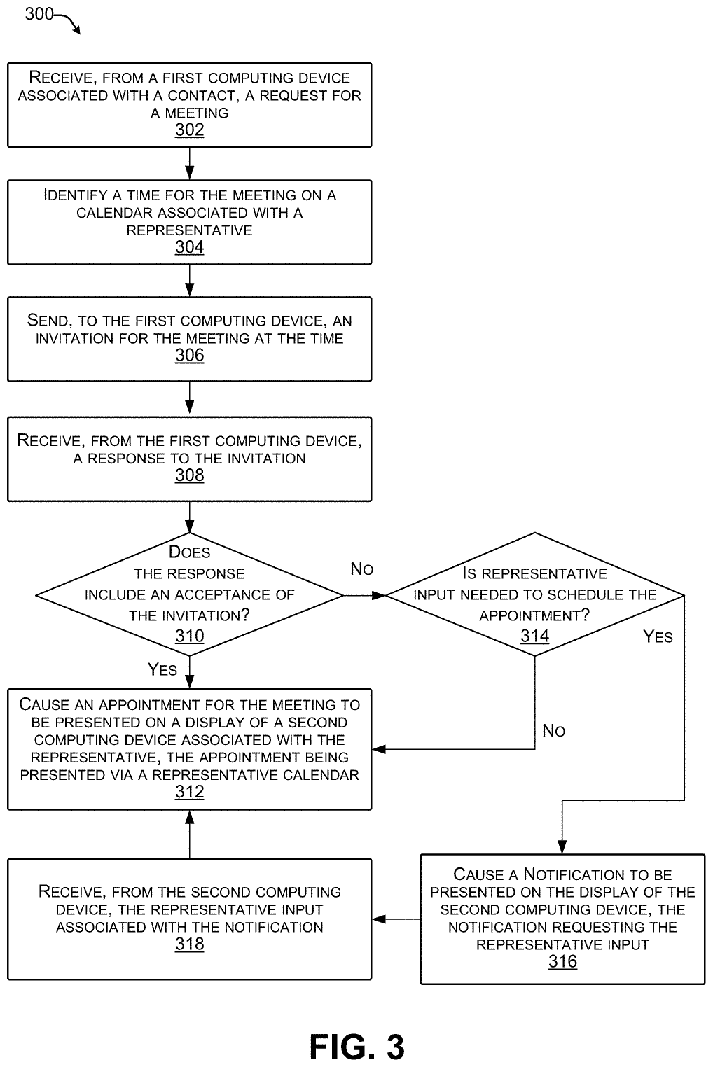

FIG. 3 illustrates an example process 300 for scheduling an appointment for a representative and causing the appointment to be presented via a calendar of the representative. As discussed herein, a scheduling platform may be configured to automatically schedule the appointment (e.g., assign the task at a particular time, during a particular time slot, etc.) for the representative. In some instances, some or all of process 300 may be performed by one or more components in the system 100 (e.g., scheduling platform 104, representative computing device 110, and/or contact computing device 112) and/or by one or more components of the system 700 of FIG. 7 (e.g., service computing device 702 and/or representative computing device 704).

At operation 302, the process 300 includes receiving, from a first computing device associated with a contact, a request for a meeting. The request for the meeting may include a request for a demonstration of capabilities, a request to meet with a particular person, a request for service support, or the like. In various examples, the scheduling platform may be configured to process a plurality of requests for meetings from a plurality of different contacts. For example, the scheduling platform may request 45 requests for demonstrations of capabilities per day.

The scheduling platform may identify one or more representatives configured for performing the task associated with the request (e.g., conducting the meeting). In some examples, the scheduling platform may determine, based on task data included in the request, a group of representatives configured to perform the task. In various examples, the scheduling platform may identify a particular representative of the one or more representatives for task assignment.

At operation 304, the process 300 includes identifying a time for the meeting on a calendar associated with a representative. The calendar may include a secondary calendar that is generated by the scheduling platform, such as described above at operation 202 of FIG. 2. In various examples, the secondary calendar may include a duplicate calendar of a representative calendar. The secondary calendar may include scheduling data, such as tentative appointments, that are withheld from view of the representative. In such examples, the tentative appointments may not be viewable to the representative, such as via the representative calendar.

In various examples, the time may include an open time on the secondary calendar in which another tentative appointment and/or a scheduled appointment is not scheduled. In some examples, the time may be determined based on one or more scheduling preferences associated with the representative. In such examples, the scheduling preferences may include times for scheduling, a number of appointments to be scheduled consecutively, a break time between appointments, and the like.

At operation 306, the process 300 includes sending, to the first computing device, an invitation for the meeting at the time. In some examples, the invitation may be sent via a scheduling application, electronic mail, text message, and/or any other means of transmitting an invitation to the contact. In various examples, the invitation may include the date and time for the meeting, and/or representative data associated with the representative (e.g., name, title, certifications, qualifications, education, contact information, etc.). In some examples, the invitation may include an accept selectable option via which the contact may quickly accept the invitation for the meeting. In some examples, the invitation may include a decline selectable option in which the contact may decline the invitation and/or suggest different times for the meeting.

At operation 308, the process 300 includes receiving, from the first computing device, a response to the invitation. The response may be sent via the scheduling application, electronic mail text message, or other means of transmitting a response. The response may be sent via a same or a different method as the invitation. In some examples, the response may include an indication of acceptance of the invitation. In some examples, the response may include an indication that the invitation has been declined by the contact. In some examples, the response may include additional information, such as an alternative time for the meeting, questions about the meeting, comments about the meeting or scheduling, or the like.

At operation 310, the process 300 includes determining whether the response includes an acceptance of the invitation. In some examples, the acceptance may include an indication of acceptance, such as an indication that the contact selected a selectable option (e.g., clicked accept on the invitation), or the like.

Based on a determination that the response includes an acceptance (or indication thereof) of the invitation (“YES” at operation 310), the process, at operation 312, includes causing an appointment for the meeting to be presented on a display of a second computing device associated with the representative, the appointment being presented via a representative calendar.

Based on a determination that the response does not include an acceptance (or indication thereof) of the invitation (“NO” at operation 310), the process, at operation 314 includes determining whether representative input is needed to schedule the appointment. In various examples, the determination that the response does not include an acceptance may be based on an indication that the contact selected a selectable option to decline the invitation.

In various examples, the scheduling platform may be configured to receive the response and process information included therein for scheduling. For example, the scheduling platform may be configured to determine that an alternative time for the meeting is included in the response. The scheduling platform may generate a new tentative schedule for the alternative time and send an updated invitation without input from the representative. In some examples, based on a determination that representative input is not needed to schedule the appointment (“NO” at operation 314), the scheduling platform may cause causing the appointment for the meeting to be presented on a display of the second computing device associated with the representative, as discussed above at operation 312.

In various examples, the scheduling platform may determine that the response includes additional information associated with scheduling the meeting. In some examples, the scheduling platform may determine that representative input is needed to understand the additional information and/or to enable effective appointment scheduling. Based on a determination that representative input is needed to schedule the appointment (“YES” at operation 314), the process includes, at operation 316, causing a notification to be presented on the display of the second computing device, the notification requesting representative input. In some examples, the notification may be presented via the representative calendar. In some examples, the notification may include a pop-up notification, an electronic mail communication, a text message, a social network messaging message, or the like.

In various examples, the notification may include data associated with the invitation, data associated with the response, and/or other data to inform the representative of the situation and/or issue with the invitation. In some examples, the notification may include a request for representative input. For example, the scheduling platform may receive a response with a list of other appointments a contact has on the day proposed in the invitation. The scheduling platform may determine, based in part on the list of other appointments, that representative input is required for scheduling. The scheduling platform may generate and send a notification including a message indicating that “we sent an invitation and got a response with too much information that we are unable to process. Will you please indicate a date and time for the meeting, and we will schedule it for you?”

At operation 318, the process 300 includes receiving, from the second computing device, representative input associated with the notification. The representative input may include a date and/or time to schedule the meeting, an indication that the representative scheduled the meeting with the contact at a particular date and/or time (e.g., schedule update), or the like. In various examples, the scheduling platform may receive the representative input and may modify the secondary calendar based on the representative input. In examples in which the representative input includes a date and/or time to schedule the meeting, the scheduling platform may modify a tentative appointment associated with the meeting to the date and/or time. In some examples, the scheduling platform may send an updated invitation to the contact including the date and/or time indicated in the representative input. In various examples, responsive to receiving an indication of acceptance of the invitation, the scheduling platform may cause the appointment for the meeting to be presented via the representative calendar, as described at operation 312.

In examples in which the representative coordinates the appointment with the contact, such as based on the notification, the representative input includes a date and/or time for a scheduled appointment. The scheduling platform may receive the date and/or time and may modify a tentative appointment for the meeting to a scheduled appointment at the date and/or time indicated by the representative input. In various examples, based on the modification to the scheduled appointment, the scheduling platform may cause the (scheduled) appointment for the meeting to be presented via the representative calendar, as described at operation 312.

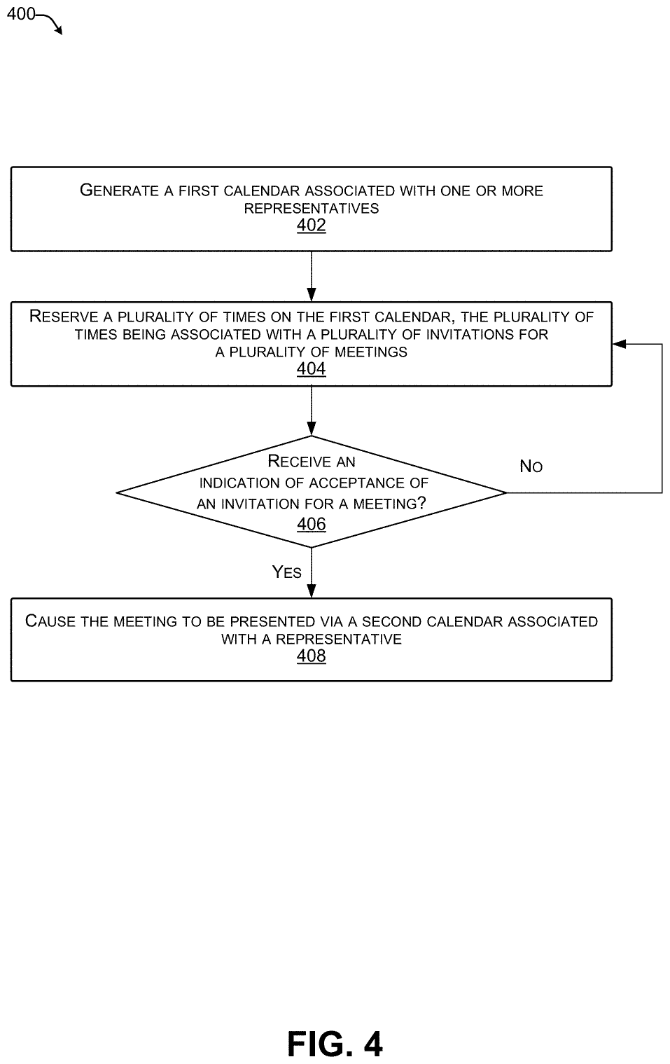

FIG. 4 illustrates an example process 400 for identifying a representative to conduct an appointment with a contact and causing the appointment to be presented via a calendar of the representative. As discussed herein, a scheduling platform may be configured to automatically schedule a meeting (e.g., assign the task at a particular time, during a particular time slot, etc.) between the representative and the contact. In some instances, some or all of process 400 may be performed by one or more components in the system 100 (e.g., scheduling platform 104, representative computing device 110, and/or contact computing device 112) and/or by one or more components of the system 700 of FIG. 7 (e.g., service computing device 702 and/or representative computing device 704).

At operation 402, the process 400 includes generating a first calendar associated with one or more representatives. In various examples, the first calendar may be generated based on one or more second calendars (e.g., representative calendars) associated with the one or more representatives. In some examples, the first calendar may include a duplicate calendar of the representative calendar(s) associated with the representative(s), such as representative calendar 118. In such examples, the first calendar may include a secondary calendar associated with the representative calendar(s). In some examples, the first calendar may be accessible to and maintained by the scheduling platform, while the second calendar(s) may be accessible to and modifiable by the representative(s) and/or the scheduling platform. For example, the representative(s) may access the second calendar via a scheduling application on one or more representative computing devices, such as rep computing device. Though discussed herein as being associated with one or more representatives, it is understood that the first calendar may include a master calendar associated with a single representative.

In some examples, the first calendar may include schedule data (e.g., appointments, meetings, reservations, tasks, blocked times, vacation days, etc.) and/or scheduling preference data (e.g., days/times for scheduling appointments, start/end times for working, etc.) associated with the second calendar of the one or more representatives. In some examples, the schedule data may include one or more one or more scheduled appointments that are currently associated with the representative(s). In such examples, the scheduled appointment(s) may include periods of time in which the one or more representatives are currently scheduled for a meeting, a task, an appointment, or is otherwise unavailable for scheduling. The scheduled appointment(s) may include periods of time that are scheduled by the scheduling platform and/or by the representative(s) via the second calendar.

In various examples, the scheduling platform may continuously and/or periodically update the first calendar to include updated schedule data. In some examples, the scheduling platform may update the first calendar based on receiving an indication that the one or more representatives added a scheduled appointment to the second calendar. In some examples, one or more representative computing devices associated with the representative(s) may send updated schedule data to the scheduling platform based on the recently added scheduled appointment. In various examples, the scheduling platform may periodically (e.g., once per hour, twice per day, daily, weekly, etc.) request and/or receive updated schedule data from the one or more representative computing devices and/or the one or more second calendar (e.g. an application associated therewith). Responsive to receiving updated schedule data, the scheduling platform may modify the first calendar to include one or more appointment(s) associated with the updated schedule data.

As discussed above, the scheduling platform may determine one or more tasks (e.g., meetings, appointments, etc.) for the representative to perform. The task(s) may include one or more work assignments for the one or more representatives to complete. In some examples, the task(s) may include conducting one or more meetings with one or more contacts. For example, a plurality of contacts may submit a plurality of requests for demonstrations of capabilities (e.g., demos) from an organization. The scheduling platform may receive the plurality of requests and determine that each of the plurality of requests includes the task of conducting a demo. The scheduling platform may determine one or more times on the first calendar associated with the representative(s) that are available to schedule appointments for each of the demos.

At operation 404, the process 400 includes reserving a plurality of times on the calendar, the plurality of times being associated with a plurality of invitations for a plurality of meetings. In various examples, each time of the plurality of times may be associated with a meeting of the plurality of meetings. In some examples, two or more times of the plurality of times may be reserved for a particular meeting of the plurality of meetings. In such examples, the invitation may include an option for contact to select a preferred time of the two or more times for the meeting. In various examples, the scheduling platform may send, to a plurality of contact computing devices, a plurality of invitations associated with the plurality of meetings.

At operation 406, the process 400 includes determining whether an indication of acceptance of an invitation for a meeting has been received. In various examples, the scheduling platform may receive the indication of acceptance from a contact computing device. In some examples, the indication of acceptance may be received responsive to the contact selecting an accept selectable option associated with the invitation. In some examples, the indication of acceptance may be received responsive to the contact modifying a contact calendar to include the meeting.

Based on a determination that an indication of acceptance is not received (“NO” at operation 406), the process 400 includes reserving the plurality of times on the first calendar, as described at operation 404.

Based on a determination that an indication of acceptance is received (“YES” at operation 406), the process 400, at operation 408, includes causing the meeting to be presented via a second calendar associated with a representative. The second calendar may include a representative calendar associated with the representative. The second calendar may be presented on a display of a representative computing device associated with the representative, such as via a scheduling application. In some examples, the scheduling platform may cause the scheduling application to present the meeting (e.g., scheduled appointment) on the display of the representative computing device.

In various examples, the scheduling platform may identify the representative to be associated with the meeting utilizing the techniques described in U.S. patent application Ser. No. 16/880,977, incorporated herein by reference above. In various examples, the scheduling component may identify the representative utilizing one or more rules. In some examples, the scheduling platform may identify the representative based on a performance score associated therewith, such as based on past performance (e.g., historical data, etc.). In various examples, the representative may be identified based on an associated performance score being equal to or greater than a threshold performance score. In some examples, the representative may be identified based on task data associated with the task. In such examples, the representative may be selected based on difficulty of the task, urgency, visibility, or the like.

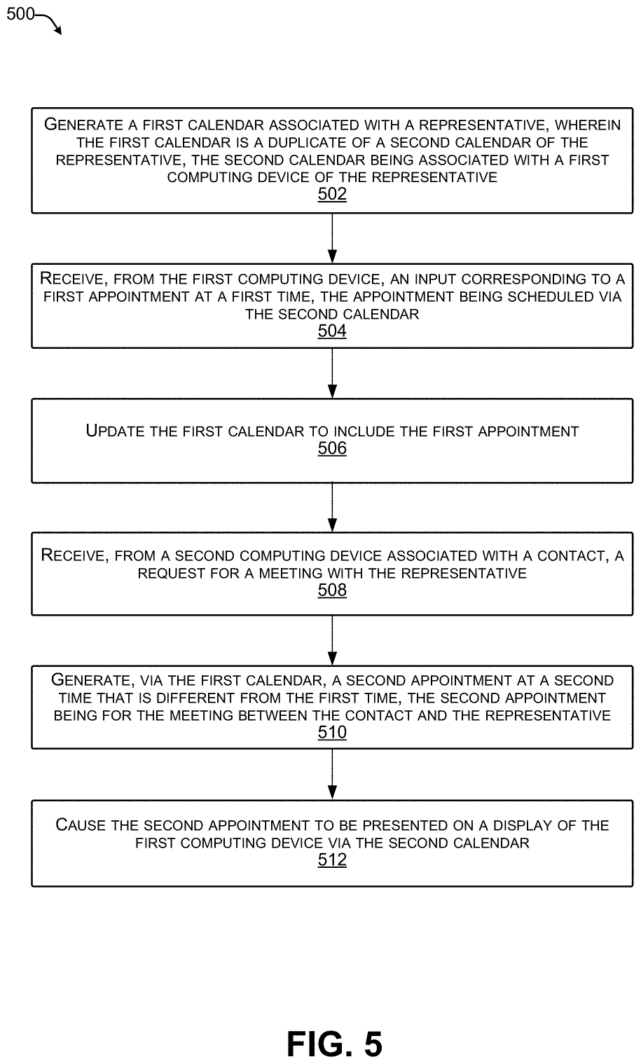

FIG. 5 illustrates an example process for updating an intelligent scheduling system calendar based on an input by a representative via a calendar of the representative. In some instances, some or all of process 500 may be performed by one or more components in the system 100 (e.g., scheduling platform 104, representative computing device 110, and/or contact computing device 112) and/or by one or more components of the system 700 of FIG. 7 (e.g., service computing device 702 and/or representative computing device 704).

At operation 502, the process 500 includes generating a first calendar associated with a representative, wherein the first calendar is a duplicate of a second calendar of the representative, the second calendar being associated with a first computing device of the representative. In some examples, the second calendar may include a representative calendar, such as representative calendar 118. In various examples, the first calendar may include schedule data and/or scheduling preference data associated with the representative. In some examples, the second calendar may be accessible to and/or modified by the representative, such as via a scheduling client application associated with the first computing device.

At operation 504, the process 500 includes receiving, from the first computing device, an input corresponding to a first appointment at a first time, the appointment being scheduled via the second calendar. In various examples, the input may be received via the scheduling client application associated with the first computing device.

At operation 506, the process 500 includes updating the first calendar to include the first appointment. In various examples, updating the first calendar may include adding a scheduled appointment to the first calendar at the time associated with the first appointment. In some examples, the scheduling platform may store schedule data associated with the first appointment in a datastore associated with the first calendar. In various examples, updating the first calendar to include the first appointment may include blocking a time period associated therewith such that another appointment cannot be scheduled at the time period.

At operation 508, the process 500 includes receiving, from a second computing device associated with a contact, a request for a meeting with the representative. The request may include task data associated with the meeting (e.g., task). The task data may include a task to be performed by the representative of an organization, and/or information about the task (e.g., a meeting type, a problem to be fixed, requested information, etc.). For example, the task data may include a request for a demonstration of capabilities of a product provided by the organization. The request may be transmitted via a communication from the contact (e.g., via email, text message, etc.) and/or may be received via data collection fields associated with an application of the contact computing device (e.g., on a web application accessed via a web browser, native application, etc.). For example, the contact may launch an application associated with the organization on a contact computing device and may submit the request for a meeting including a request for assistance with a software program provided by the organization. The request may include task data describing the problem the contact is experiencing. In some examples, the task data may include an urgency associated with the request (e.g., level of importance, etc.). For example, the task data may include a tier 1 level request for information technology (“IT”) support.

At operation 510, the process 500 includes generating, via the first calendar, a second appointment at a second time that is different from the first time, the second appointment being for the meeting between the contact and the representative. In some examples, the second appointment may be generated based on receiving an indication of acceptance of an invitation associated with the second appointment. For example, the scheduling platform may determine the second time associated with the second appointment and may generate a tentative appointment at the second time. The scheduling platform send the invitation for second appointment to the second computing device. In response to receiving the indication of acceptance of the invitation for the second appointment, the scheduling platform may modify the tentative appointment into the second (scheduled) appointment.

At operation 512, the process 500 includes causing the second appointment to be presented on a display of the first computing device via the second calendar. In some examples, the second appointment may be presented via a scheduling client application (e.g., an instance of a scheduling application managed by the scheduling platform). In various examples, the scheduling platform may withhold information about the second appointment from the first computing device and/or the representative calendar (e.g., the second calendar) until the second appointment is accepted by the contact, is modified from a tentative appointment to a scheduled appointment, and/or is relevant to the representative. As such, the techniques described herein may limit data transmitted to the first computing device (and presented therethrough) to data that is relevant to the representative. Accordingly, the techniques described herein may improve the functioning of the first (representative) computing device by reducing a total amount of data transmitted to and/or processed by the first computing device.

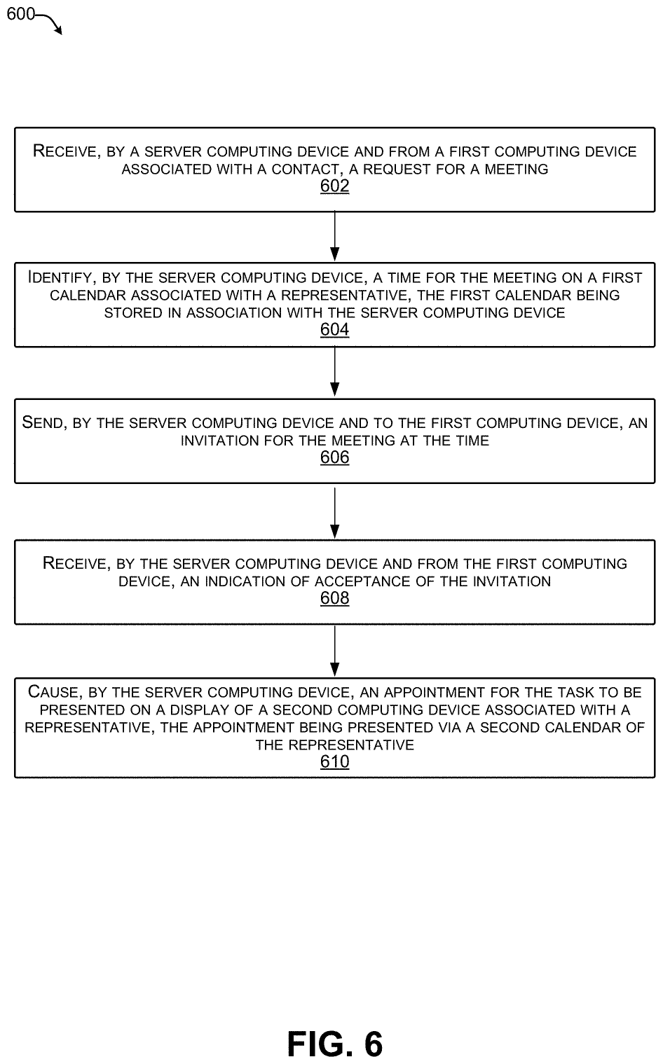

FIG. 6 illustrates an example process for scheduling an appointment for a representative and causing the appointment to be presented via a second calendar of the representative. As discussed herein, a scheduling platform may be configured to automatically schedule a task (e.g., assign the task at a particular time, during a particular time slot, etc.) for a representative. In some instances, some or all of process 600 may be performed by one or more components in the system 100 (e.g., scheduling platform 104, representative computing device 110, and/or contact computing device 112) and/or by one or more components of the system 700 of FIG. 7 (e.g., service computing device 702 and/or representative computing device 704).

At operation 602, the process 600 includes receiving, by a server computing device (e.g., scheduling platform, service computing device, etc.) and from a first computing device associated with a contact, a request for a meeting. The request may include task data associated with the meeting (e.g., task). The task data may include a task to be performed by a representative of an organization, and/or information about the task (e.g., a meeting type, a problem to be fixed, requested information, etc.). The request may be transmitted to the server computing device via a communication from the contact (e.g., via email, text message, etc.) and/or may be received via data collection fields associated with an application of the contact computing device (e.g., on a web application accessed via a web browser, native application, etc.). For example, the contact may launch an application associated with the organization on a contact computing device and may submit the request for a meeting including a request for assistance with a software program provided by the organization. The request may include task data describing the problem the contact is experiencing. In some examples, the task data may include an urgency associated with the request (e.g., level of importance, etc.). For example, the task data may include a tier 1 level request for information technology (“IT”) support.

At operation 604, the process 600 includes identifying, by the server computing device, a time for the meeting on a first calendar associated with a representative, the first calendar being stored in association with the server computing device. In various examples, the first calendar may include a duplicate calendar of a second (representative) calendar of the representative. The second calendar may include a calendar that is accessible to and modifiable by the representative, whereas the first calendar may be stored and accessible to the server computing device. In various examples, the server computing device may generate the first calendar based on the second calendar of the representative. In some examples, the server computing device may periodically, continuously, and/or intermittently update the first calendar to include data included in the second calendar. In such examples, the scheduling data and/or scheduling preference data added and/or modified in the second calendar may be transmitted to the server computing device in one or more scheduling updates. In various examples, the first calendar may include a real-time and/or near real-time duplicate calendar of the second calendar of the representative.

At operation 606, the process 600 includes sending, by the server computing device and to the first computing device, an invitation for the meeting at the time. In various examples, the invitation may be sent via a scheduling application, email, text message, social networking message, or the like. In various examples, the invitation may include a date and time for the meeting, a representative assigned to the meeting, representative data, task data (e.g., information about the meeting), and/or other data relevant to the contact. In some examples, the invitation may include an accept selectable option, enabling the contact to easily accept the invitation, such as with a single click. In various examples, the invitation may provide a means by which the contact may submit a response to the invitation. The response may include an indication of declining the invitation, another proposed time (or times) for the meeting, and/or other information.

At operation 608, the process 600 includes receiving, by the server computing device and from the first computing device, an indication of acceptance of the invitation. In some examples, the indication of acceptance of the invitation may include an indication that the contact selected the accept selectable option associated with the invitation, added the meeting to a contact calendar, and/or means by which the server computing device may determine that the contact accepted the meeting.

At operation 610, the process 600 includes causing, by the server computing device, an appointment for the task to be presented on a display of a second computing device associated with a representative, the appointment being presented via a second calendar of the representative. In some examples, the appointment may be presented via a scheduling client application (e.g., an instance of a scheduling application managed by the server computing device). In various examples, the server computing device may withhold information about the appointment from the second computing device and/or the representative calendar (e.g., the second calendar) until the appointment is accepted by the contact, is modified from a tentative appointment to a scheduled appointment, and/or is relevant to the representative. As such, the techniques described herein may limit data transmitted to the second computing device (and presented therethrough) to data that is relevant to the representative. Accordingly, the techniques described herein may improve the functioning of the second (representative) computing device by reducing a total amount of data transmitted to and/or processed by the first computing device.

FIG. 7 is a block diagram illustrating an example system 700 including a service computing device 702 and a representative computing device 704, usable to implement example techniques described herein. The service computing device 702 may include one or more servers or other types of computing devices that may be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

The service computing device 702 and/or the representative computing device 704 may be any suitable type of computing device, e.g., mobile, semi-mobile, semi-stationary, or stationary. The service computing device 702 and/or the representative computing device 704 may belong to a variety of categories or classes of devices such as traditional server-type devices, desktop computer-type devices, mobile devices, special purpose-type devices, embedded-type devices, and/or wearable-type devices. Thus, service computing device 702 and/or the representative computing device 704 may include a diverse variety of device types and are not limited to a particular type of device. For example, the service-computing device 702 and/or the representative computing device 704 may represent, but are not limited to, desktop computers, server computers or blade servers such as web-servers, map-reduce servers, or other computation engines or network-attached storage units, personal computers, mobile computers, laptop computers, tablet computers, telecommunication devices, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device capable of sending communications and performing the functions according to the techniques described herein.

In the illustrated example, the service computing device 702 includes at least one processor 706 and the representative computing device 704 includes at least one processor 708. Each processor 706 and/or 708 may itself comprise one or more processors or processing cores. For example, the processor 706 and/or 708 may be implemented as one or more microprocessors, microcomputers, microcontrollers, digital signal processors, central processing units, state machines, logic circuitries, and/or any devices that manipulate signals based on operational instructions. In some cases, the processor 706 and/or 708 may be one or more hardware processors and/or logic circuits of any suitable type specifically programmed or configured to execute the algorithms and processes described herein. The processor 706 and/or 708 may be configured to fetch and execute computer-readable processor-executable instructions stored in a memory 710 of the service computing device 702 and/or a memory 712 of the representative computing device 704. In some examples, the processor 706 associated with the service computing device 702 may be the same or different from the processor 708 associated with the representative computing device 704.

Depending on the configuration of the service computing device 702 and/or the representative computing device 704, the memory 710 and/or 712 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 710 and/or 712 may include, but is not limited to, RAM, ROM, EEPROM, flash memory, solid-state storage, magnetic disk storage, optical storage, and/or other computer-readable media technology. Further, in some cases, the service computing device 702 and/or the representative computing device 704 may access external storage, such as RAID storage systems, storage arrays, network attached storage, storage area networks, cloud storage, or any other medium that may be used to store information and that may be accessed by the processor 706 and/or 708 directly or through another computing device or network. Accordingly, the memory 710 and/or 712 may be computer storage media able to store instructions, modules or components that may be executed by the processor 706 and/or 708. Further, when mentioned, non-transitory computer-readable media exclude media such as energy, carrier signals, electromagnetic waves, and signals per se.

The memory 710 and/or the memory 712 may be used to store and maintain any number of functional components that are executable by the respective processor 706 and/or 708. In some implementations, these functional components comprise instructions or programs that are executable by the respective processors 706 and/or 708 and that, when executed, implement operational logic for performing the actions and services attributed above to the service computing device 702 and/or the representative computing device 704. Functional components of the service computing device 702 stored in the memory 710 may include a scheduling application 714, such as scheduling application 102, a calendar generation component 716, such as calendar generation component 126, a scheduling component 718, such as scheduling component 128, a training component 720, such as training component 132. Additionally, functional components of the service computing device 702 stored on the memory 710 may include one or more organization and/or representative profiles 722, such as those stored in profile(s) 122, contact profiles 724, such as contact profiles 124, one or more operating system(s) 726, and/or other components and data 728.

Functional components of the and/or the representative computing device 704 may include a scheduling client application 730, such as the instance of the scheduling app 102(1), a representative calendar 732, such as representative calendar 118, one or more representative profiles 734, such as profile(s) 120, one or more operating systems 736, and/or other components and data 738.

As discussed above, the service computing device 702 may include a scheduling application 714 for scheduling one or more tasks with representatives. In some examples, the service computing device 702 may manage the scheduling client application 730 on the representative computing device 704. In some examples, the service computing device 702 may include an application programming interface between the scheduling application 714 and the scheduling client application 730.

In various examples, the calendar generation component 716 of the service computing device 702 may be configured to generate a secondary calendar associated with a representative calendar 732 corresponding to the representative computing device 704. In some examples, the secondary calendar may include a master calendar that is used for scheduling appointments between one or more representatives and a plurality of contacts. In some examples, the secondary calendar may include a duplicate of the representative calendar 732. In various examples, the scheduling client application 730 may send schedule updates to the scheduling application 714, such as with new appointments that have been scheduled by the representative, updated preferences, and the like. In various examples, the schedule updates may be sent periodically, such as three times a day, daily, weekly, or the like. In various examples, the schedule updates may be sent intermittently, such as in response to determining that schedule data and/or schedule preference data associated with the scheduling client application 730 has been updated. Responsive to receiving the schedule updates, the calendar generation component 716 may update the secondary calendar to include the recently added schedule data and/or schedule preference data.

In various examples, the scheduling component 718 of the service computing device 702 may determine a task, such as that received from a contact, received from a computing device associated with an organization, or determined based on an organizational preference stored in the profile(s) 722. In various examples, the scheduling component 718 may identify a representative for task assignment. The scheduling component 718 may determine the representative based on one or more scheduling models, one or more rules, and/or a performance score associated therewith, such as those described in U.S. patent application Ser. No. 16/880,977, incorporated herein by reference above. The scheduling component 718 may determine a time on the secondary calendar associated with the representative and may schedule the task to be completed. As discussed above, the time may be determined based on one or more organizational or representative scheduling preferences.

In some examples, the task may include a task for the representative to conduct alone. In such examples, the scheduling component 718 may cause an appointment for the task to be presented via the representative calendar 732. In some examples, the task may include a meeting between the representative and a contact. In such an example, the scheduling component 718 may send an invitation to the contact for the meeting (e.g., appointment). Responsive to receiving an indication of acceptance of the invitation, the scheduling component 718 may cause the appointment for the task to be presented via the representative calendar 732. In various examples, the scheduling component 718 may withhold data associated with pending appointments (e.g., not yet accepted) from presentation via the representative calendar. In such examples, the representative calendar 732 may not include pending appointments.

As discussed above, the service computing device 702 may include a training component 720. In various examples, the training component 720 may access task data, contact data, organizational data, and/or representative data and may process the data to train one or more data model(s) 740, such as data model(s) 134 of FIG. 1. In some examples, the data model(s) 740 may be trained to determine groups of representatives configured to perform a particular task. In some examples, the data model(s) 740 may be trained to determine a particular representative of the group of representatives for task assignment. In some examples, the data model(s) 740 may be trained to determine a time associated with a calendar of an identified representative that may optimize performance of the task and/or efficiency of the representative. In some examples, the training component 720 may utilize machine learning techniques to train the data model(s) 740.

Additionally or alternatively, the data model(s) 740 may utilize one or more statistical models for processing data and determining an outcome.

Additional functional components of the service computing device 702 and/or the representative computing device 704 may include the operating system 726 and operating system 736, for controlling and managing various functions of the service computing device 702 and/or the representative computing device 704, respectively. The memories 710 and/or 712 may also store other components and data 728 and/or 738, which may include programs, drivers, etc., and the data used or generated by the functional components, to enable task scheduling and task presentation to the representative. Further, the service computing device 702 and/or the representative computing device 704 may include many other logical, programmatic and physical components, of which those described are merely examples that are related to the discussion herein. In addition, the memories 710 and/or 712 may also store data, data structures and the like, that are used by the functional components.

In various examples, the service computing device 702 and/or the representative computing device 704 may include one or more input/output (I/O) interfaces 742 and 744, respectively. The I/O interface(s) 742 and/or 744, may include speakers, a microphone, a camera, and various user controls (e.g., buttons, a joystick, a keyboard, a keypad, etc.), a haptic output device, and so forth. Additionally, the service computing device 702 and/or the representative computing device 704 may include one or more network interfaces 746 and/or 748, respectively. The network interface(s) 746 and/or 748 may include one or more interfaces and hardware components for enabling communication with various other devices over the network or directly. For example, network interface(s) 746 and/or 748 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

In various examples, the representative computing device 704 may include one or more displays 750. Depending on a type of computing device used as the representative computing device 704, the display(s) 750 may employ any suitable display technology. For example, the display(s) 750 may include liquid crystal displays, a plasma displays, a light emitting diode displays, OLED (organic light-emitting diode) displays, electronic paper displays, or any other suitable type of displays able to present digital content thereon. In some examples, the display(s) 750 may have a touch sensor associated therewith to provide a touchscreen display configured to receive touch inputs for enabling interaction with a graphical user interface presented on the display(s) 750. Accordingly, implementations herein are not limited to any particular display technology.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims. Furthermore, while techniques described herein are directed to techniques associated with scheduling services, similar techniques can be applicable for any type of services and should not be construed as being limited to only scheduling services.

What is claimed is:

1. A method, implemented at least in part by a service computing device, the method comprising:
identifying a first calendar associated with a representative, wherein the first calendar comprises one or more scheduled tasks associated with the representative;
generating, based at least in part on the first calendar, a second calendar associated with the representative;
receiving, from a contact computing device associated with a contact, a request to schedule a new task;
based at least in part on a determination to associate the representative with the new task, identifying at least one time on at least one of the first calendar or the second calendar to associate with the new task;
associating the new task with the at least one time on the second calendar, wherein the new task is represented in association with the second calendar as a tentative task;
sending, to the contact computing device, an invitation for the new task at the at least one time; and
in response to receiving, from the contact computing device, an indication of acceptance of the invitation for the new task at a time of the at least one time, causing presentation, in association with the first calendar on a representative computing device of the representative, of an indicator associated with the new task at the time.

2. The method of claim 1, wherein the determination to associate the representative with the new task comprises:
identifying, based at least in part on the request to schedule the new task, a characteristic associated with the new task; and
identifying, based at least in part on the characteristic, the representative from a group of representatives available to perform the new task.

3. The method of claim 1, wherein the determination to associate the representative with the new task comprises:
identifying one or more rules corresponding to associating representatives to tasks; and
identifying, based at least in part on the one or more rules, the representative from a group of representatives available to perform the task.

4. The method of claim 1, further comprising:
receiving, from the representative computing device of the representative and via the second calendar, an indication that the representative has scheduled an appointment on the second calendar during a period of time; and
updating the first calendar based at least in part on the indication that the representative has scheduled the appointment on the second calendar, wherein an update to the first calendar includes rendering the period of time unavailable for scheduling an additional appointment.

5. The method of claim 1, further comprising:
receiving, from the representative computing device of the representative and via the second calendar, an indication that the representative has canceled an appointment on the second calendar during a period of time; and
updating the first calendar based at least in part on the indication that the representative has canceled the appointment on the second calendar, wherein an update to the first calendar includes rendering the period of time available for scheduling an additional appointment.

6. The method of claim 1, wherein:
identifying the at least one time on the at least one of the first calendar or the second calendar comprises identifying a first time and a second time that are available on the at least one of the first calendar or the second calendar, and
the invitation for the new task comprises a first selectable option to accept the invitation for an appointment at the first time and a second selectable option to accept the invitation for the appointment at the second time, and
the indication of acceptance of the invitation for the new task at the time comprises an indication of selection of the first selectable option or the second selectable option.

7. The method of claim 1, wherein the indicator comprises at least an indication of a scheduled appointment associated with the new task and data associated with the new task.

8. A system comprising:
one or more processors; and
computer-readable media storing instructions that, when executed, cause the system to perform operations comprising:
generating a first calendar for scheduling appointments for a representative based at least in part on a second calendar associated with the representative, wherein the first calendar and the second calendar both comprise at least one scheduled appointment associated with the representative;
generating, in association with the first calendar, a tentative appointment for a task to associate with the representative, wherein the tentative appointment is generated in response to receiving, from a contact computing device associated with a contact, a request for the task to be completed;
sending, to the contact computing device, an invitation for the tentative appointment; and
in response to receiving, from the contact computing device, an indication of acceptance of the invitation, causing presentation of the tentative appointment in association with the second calendar, wherein the tentative appointment is presented as a scheduled appointment.

9. The system of claim 8, the operations further comprising:
identifying, based at least in part on the request for the task to be completed, a characteristic associated with the task;
identifying, based at least in part on the characteristic, the representative from a group of representatives configured to perform the task; and
associating, based on an identification of the representative from the group of representatives, the representative with the task, wherein the tentative appointment is generated in response to an association of the representative with the task.

10. The system of claim 8, the operations further comprising:
receiving, from a representative computing device of the representative and via the second calendar, an indication that the representative has scheduled an appointment on the second calendar during a period of time; and
updating the first calendar based at least in part on the indication that the representative has scheduled the appointment on the second calendar, wherein an update to the first calendar includes rendering the period of time unavailable for scheduling an additional appointment.

11. The system of claim 8, wherein the representative is a first representative of a plurality of representatives, the operations further comprising:
determining a first performance score associated with the first representative and a second performance score associated with a second representative of the plurality of representatives; and
associating the task with the first representative based at least in part on the first performance score,
wherein the tentative appointment for the task is generated based at least in part on an association between the task and the first representative.

12. The system of claim 8, wherein the representative is a first representative, the task is a first task, and wherein the first calendar is further generated based in part on a third calendar associated with a second representative, the operations further comprising:
receiving, from a second contact computing device associated with a second contact, a second request for a second task to be completed;
associating the second task with the second representative;
generating a second tentative appointment for the second task on the first calendar, the second tentative appointment being associated with a time on the third calendar in which the second representative is available; and
in response to a determination that an invitation for the second tentative appointment is accepted by the second contact, causing presentation of the second tentative appointment in association with the third calendar, wherein the second tentative appointment is presented as a second scheduled appointment.

13. The system of claim 12, wherein the second task is associated with the second representative based at least in part on at least one of:
an association of the first task with the first representative;
a task characteristic associated with the second task;
a representative characteristic associated with the second representative; or
one or more available times associated with the third calendar.

14. The system of claim 8, wherein the first calendar comprises a duplicate of the second calendar.

15. One or more non-transitory computer-readable media storing computer-executable instructions that, when executed by one or more processors of a computing device, cause the computing device to perform operations comprising:
generating a first calendar for scheduling appointments for one or more representatives;
generating, in association with the first calendar, a plurality of tentative appointments for a plurality of tasks to associate with the one or more representatives, wherein at least one tentative appointment of the plurality of tentative appointments is generated in response to receiving, from a contact computing device associated with a contact, a request for a task to be completed; and
in response to a determination that the at least one tentative appointment is confirmed with the contact, causing presentation of the tentative appointment in association with a second calendar associated with a representative of the one or more representatives, wherein the tentative appointment is presented as a scheduled appointment on the second calendar associated with the representative.

16. The one or more non-transitory computer-readable media of claim 15, the operations further comprising:
identifying, based at least in part on the request for the task to be completed, a characteristic associated with the task;
identifying, based at least in part on the characteristic, the representative of the one or more representatives to perform the task; and
associating the representative with the task, wherein the scheduled appointment is presented on the second calendar associated with the representative based on an association of the representative with the task.

17. The one or more non-transitory computer-readable media of claim 15, wherein the request for the task to be completed comprises a request for the representative to perform the task, the operations further comprising:
identifying an available time on the second calendar associated with the representative;
generating a tentative appointment for the task at the available time;
generating an invitation for an appointment between the representative and the contact at the available time;
sending, to the contact computing device, the invitation for the appointment; and
receiving, from the contact computing device, an indication of acceptance of the invitation,
wherein the determination that the at least one tentative appointment is confirmed with the contact is based at least in part on receiving the indication of acceptance of the invitation.

18. The one or more non-transitory computer-readable media of claim 15, wherein the determination that the at least one tentative appointment is confirmed comprises:
sending, to the contact computing device, an invitation for the at least one tentative appointment; and
receiving, from the contact computing device, an indication of acceptance of the invitation.

19. The one or more non-transitory computer-readable media of claim 15, the operations further comprising:
receiving, from a representative computing device of the representative and via the second calendar, an indication that the representative has canceled an appointment on the second calendar during a period of time; and
updating the first calendar based at least in part on the indication that the representative has canceled the appointment on the second calendar, wherein an update to the first calendar includes rendering the period of time available for scheduling an additional appointment with the representative.

20. The one or more non-transitory computer-readable media of claim 15, wherein the first calendar comprises a master calendar associated with the one or more representatives.
